(19) United States
(12) Patent Application Publication
(10) Pub. No.: US 2007/0005991 A1
(43) Pub. Date: Jan. 4, 2007

(54) Method for checking the data integrity of software in control appliances

(75) Inventors: Heiko Kober, Calw (DE); Jutta Schneider, Tubingen (DE); Eva Weiser, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/552,744

(22) PCT Filed: Feb. 24, 2004
(86) PCT No.: PCT/EP04/01807

§ 371 Date: Aug. 8, 2006

(30) Foreign Application Priority Data
Apr. 12, 2003 (DE) 103 16 951.2

(51) Int. Cl. G06F 12/14

(52) U.S. Cl. 713/193

(57) ABSTRACT

In checking the data integrity of software for transmission errors and authenticity during a download process, the flashed data is checked repeatedly. Such checking is configured in an efficient way by performing the calculation methods for checking for transmission errors and for checking for authenticity while the flashware is located in a buffer with a fast access time, so that lengthy access processes to the flash memory are avoided. It is therefore necessary to access the flash memory only once in order to buffer the flashware in a buffer with a fast access time for all the necessary checks.

This application claims the priority of German patent document 103 16 951.2, filed Apr. 12, 2003 (PCT International Application No. PCT/EP/2004/001807, filed Feb. 24, 2004), the disclosure of which is expressly incorporated by reference herein.

### BACKGROUND AND SUMMARY OF THE INVENTION

The invention relates to a method for updating and loading at least one user program, referred to as flashware, which is to be stored in a program memory of a microprocessor system. The download process is carried out by means of a system interface.

The program memory is divided into an electrically erasable and programmable memory, referred to as a flash, and into a volatile read/write memory, referred to as a random access memory. Before the flashware which is to be downloaded is stored in the flash memory, the downloaded program data is checked for integrity and authenticity.

A method for updating and loading user programs into a program memory of a microprocessor system is disclosed in German patent document DE 195 06 957 C2. Flashware, which is read into the flash memory of a microprocessor system via a system interface, is first buffered in a static read/write memory, referred to as a static random access memory (SRAM), and checked for transmission errors by means of a cyclic block protection method. There is no checking for authenticity of the downloaded flashware program here.

On the other hand, German patent document DE 100 08 974 A1 discloses a signature method for checking the authenticity of flashware for a control device in a motor vehicle. In this method, the flashware is provided with what is referred to as an electronic signature. In order to produce the electronic signature, what is referred to as a hash code is generated from the flashware by means of the hash function which is known per se. This hash code is encrypted by means of a public key method. (The public key method used is preferably the RSA method, named after the inventors Rivest, Shamir and Adleman.) The encrypted hash code is appended to the application program to be transmitted. In the control device, the encrypted hash code is decrypted with the public key and flashware is used to compare it with the hash code calculated in the control device. If both hash codes correspond, the transmitted flashware is authentic. Checking for transmission errors does not feature in the signature method.

One object of the present invention is to provide a method for checking the data integrity of software in control devices, in which the transmitted data can be checked for transmission errors and authenticity in the most efficient way possible.

When the data integrity of software is checked for transmission errors and authenticity during a download process, the flashed data must be checked repeatedly. The access (or access time) to program data which is stored in the flash memory is lengthy. Particularly in the case of control devices in a motor vehicle (which generally have low computing power for reasons of cost), a long access time for complex calculations such as authenticity checking gives rise to long and unacceptable delays. According to the invention, the checking of program data for transmission errors and authenticity can be configured in an efficient way if the calculation methods for checking for transmission errors and for checking for authenticity are carried out as long as the flashware is located in a buffer with a fast access time. Lengthy access processes to the flash memory are therefore avoided.

While in the past it has been necessary to access the flash memory whenever the flashware was checked, with the method according to the invention it is only necessary to access the flash memory once in order to buffer the flashware in a buffer with a fast access time for all the necessary checks.

One advantage which is achieved with the invention is the time efficient calculation of a plurality of checksums and (if appropriate) of additional signature checking by reducing the access processes to the flash memory. This permits shorter flash times for the download process, and thus numerous savings in production time.

Known methods are advantageously used for the authenticity checking. Established standards are, for example, the RSA signature of flashware or the use of what is referred to as a message authentication code. Both previously known authentication checks may advantageously be used in conjunction with the invention.

In one alternative configuration of the method according to the invention, the security class which is to be applied for authenticity checking is interrogated and is selected before the authenticity checking. As a result, the invention can be used both for flashware with a low security class and for flashware with a high security class.

Other objects, advantages and novel features of the present invention will become apparent from the following detailed description of the invention when considered in conjunction with the accompanying drawings.

### BRIEF DESCRIPTION OF THE DRAWINGS

FIG. 1 is a block diagram of a control device with a microprocessor and a logically functional division of the memory area;

FIG. 2 illustrates the division of a memory into logic blocks, in which case each logic block may be composed of a plurality of segments, with the programmed data (flashware) being stored in the segments, and the gaps between the segments being filled with what is referred to as illegal opcode or illegal data; and

FIG. 3 shows a flowchart for the method according to the invention.

### DETAILED DESCRIPTION OF THE DRAWINGS

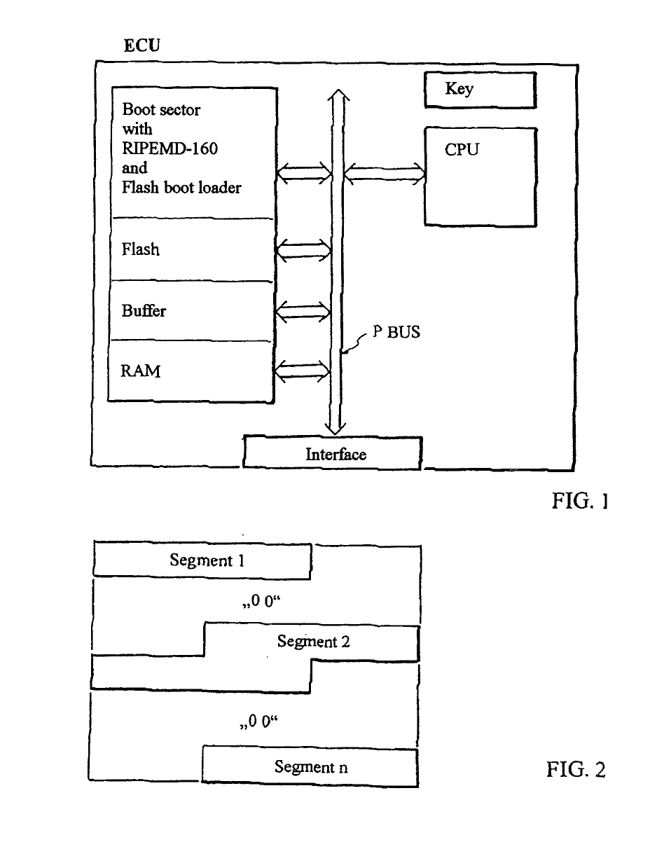

FIG. 1 shows a typical microprocessor system such as is used in control devices for motor vehicles. A microprocessor (CPU) 1, a system memory 2 and a system interface for communication with external systems are connected to a process bus PBUS. The system memory is divided logically and functionally into various memory areas, which may either be physically separated from one another or be by purely logical segmentation in a physically uniform memory.

The operating system for the microprocessor is itself essentially stored in the boot sector 2a of the microprocessor system. What is referred to as a flash boot loader is also stored as an application program in the boot sector. When necessary, new application programs are downloaded via the system interface with this flash boot loader and stored in the hash memory of the microprocessor system. Furthermore, the flash function (referred to as the RIPEMD-160 algorithm) is stored in the boot sector.

The application programs with which the control device CC operates are typically stored in the flash memory 2b of the microprocessor system. The flash memory is an electrically erasable and programmable non-volatile memory. Such memories are known as EEPROMs.

In order to apply the method according to the invention, the microprocessor system contains a buffer 2c, which may be embodied as a separate memory (for example what is referred to as a cache memory) or may be embodied as a reserved memory area within the read/write memory RAM 2d of the microprocessor system. The necessary data, intermediate results and results are read into the read/write memory RAM by the application programs and stored, buffered and output.

For the purposes of authentication checks, either a key in the form of a deciphering code or in the form of a secret code is stored in a particularly protected read only memory. A deciphering code is required for encryption methods, while a code is required for simplified authentication methods such as, for example, the message authentication codes.

With a microprocessor system constructed in this way it is possible to download application programs as what is referred to as flashware with a download process such as is described, for example, in German patent document DE 195 06 957 C2, and to store them in the flash memory. According to the structure of FIG. 1 it is also possible to use a microprocessor system to carry out authentication methods which are standardized for the flashware to be downloaded. As used to describe the present invention, on the one hand established signature methods such as, for example, the public key encryption are referred to as authentication methods, and, on the other hand, what are referred to as message authentication codes are referred to. An example of a signature method for flashware, based on a public key method, is disclosed in detail in German patent document DE 100 08 974 A1.

The RSA encryption method has been adopted as the standard public key encryption method. In this method, at first a hash value with a hash function which is known per se, for example the function RIPEMD-160, is generated from the message to be sent. The transmitter encrypts this calculated hash value with a private and secret key. The encrypted hash value forms the signature and is appended to the message to be sent. The receiver of a message decrypts the signature with a public key, thus obtaining again the hash value calculated by the transmitter. Furthermore, the receiver of the message calculates the hash value of the message from the unencrypted original message with the same hash function as the transmitter. If the hash value from the decrypted signature and the hash value which has been calculated by means of the unencrypted message correspond to one another, the message is integral and authentic. Public key encryption methods fulfill high security requirements in terms of data integrity and authenticity. With respect to control devices in motor vehicles and the download process of flashware for these control devices, public key methods fulfill the requirements for this highest security class for the download process of the flashware.

However, public key encryption methods are complex, employing complex encryption and decryption algorithms, and cannot be used on every microprocessor in a control device of a motor vehicle. For example, the encryption methods operate with floating decimal point operations which are not always supported by microprocessors in simple control devices.

Authentication methods of a lower security level do not require enciphering and deciphering. Such a method has become prevalent as what is referred to as a message authentication code MAC, which operates with a secret identification code that all the parties to the communication must know and have. This authentication code is appended to the unencrypted message and a hash value is calculated from the message distinguished in this way by means of a hash function. The unencrypted message and the calculated hash value are then exchanged between the parties to the communication. A receiver checks the transmitted message by appending his identification code to the unencrypted message, and calculates the hash value from this using the same hash function as the transmitter. If this calculated hash value corresponds to the hash value transmitted by the transmitter, the received message is considered to be integral and authentic.

The authentication messages on the basis of the previously described message authentication code have the advantage that only one method which is known per se is required for calculating hash values. (Further enciphering or deciphering steps such as, for example, RSA encryption are not required.) The hash value functions can also be carried out on very simple microprocessors. The application of message authentication codes is covered, for example, by patent U.S. Pat. No. 6,064,297. However, message authentication codes have previously been known only in internet applications or (as in the case of the cited US patent) in computer networks.

FIG. 2 illustrates the physical division of data in a logic or physical memory area or memory block. Not all the memory areas in a memory block are generally occupied with data. The useful data in a memory is generally located in various segments in which the memory area was written to. The memory areas which do not have useful data written to them are filled with what is referred to as illegal opcode or illegal data between the individual segments segment 1, segment 2 to segment N, as are illustrated in FIG. 2. The illegal opcode means, for example, that the memory areas to which useful data is not written are filled with logic zeros.

In order to check logic memory blocks and to check copying processes for transmission errors, cyclic block protection methods were developed in information technology. In their English designation these cyclic block protection methods are known as cyclic redundancy checks, CRC for short. This is a method for checking transmission errors by means of a checksum. A simple example of a checksum is the parity bit which is calculated as a checksum and appended at each information packet which is 8 bytes long, 16 bytes long, 32 bytes long and 64 bytes long. The parity bit gives information here as to whether the number of logical “ones” in the information packet is even or odd. A copying process is then considered to be free of errors if the checksum parity has not changed during the copying process. The cyclic block protection methods are calculated either as a checksum of the entire logic memory block (i.e., useful data in the segments plus filled in gaps), or as a checksum by means of the useful information in the segments alone. The checksum of the entire logic block is referred to here by CRC_total, while the checksum by means of the useful data in the segments is referred to here by CRC_written.

The cyclic block protection methods for checking the copying process per se are also applied during the process of downloading flashware into the flash memories of a control device in a motor vehicle. Cyclic block protection methods require, like a hash function, access to the useful data whose copying process or whose hash value is to be calculated. However, hitherto the cyclic block protection methods were completely separated from the authentication methods operating by means of a hash value method. That is, the block protection methods were carried out first and completed before a hash value was calculated for the authentication method.

As a result, in the past in each case read access processes to the flash memory were necessary for the block protection methods on the one hand and for the hash value calculation in the subsequent identification method, on the other. The invention addresses this point.

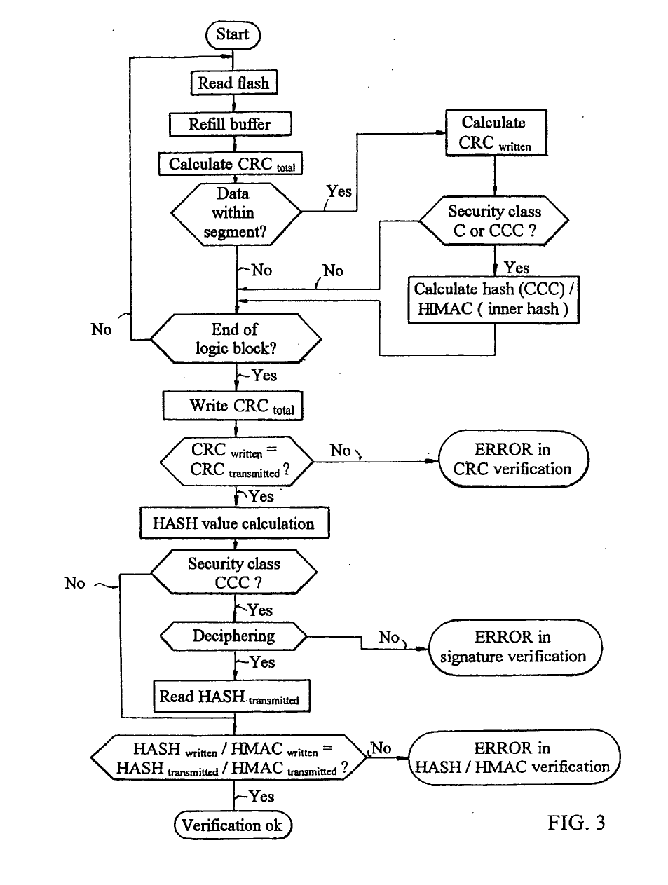

FIG. 3 is a flow diagram of an optimized process for downloading flashware according to the invention. In addition to a cyclic block protection method, an authentication method, based on the calculation of hash values, is also carried out. The flashware which is downloaded into the flash memory is first read out of the flash memory (read flash) in step 201, and buffered in the buffer (refill buffer, step 202). In the next step 203, a checksum is calculated by means of the entire flash memory using a cyclic block protection method by means of all the data which has been buffered in the buffer and copied from the flash memory. The integrity of the flash memory can be checked later using this checksum CRC_total.

In a subsequent interrogation step 204 it is determined whether the read-out flash memory contains useful data. If no useful data is present, an error 208 is not output immediately but rather only when there has been a comparison (steps 205-207) between the calculated checksum CRC_written with the checksum CRC_transmitted which is transferred during the download process. The checksum CRC_total is stored and is thus available for a later selfcheck.

If the read-out flash memory contains useful data, a separate block protection method is carried out for this useful data. This block protection method for the useful data is carried out only for those memory areas in which the useful data is stored. The calculated checksum CRC_written 209 is compared later with the checksum for the useful. data of the original software CRC_transmitted which was transmitted during the download process. Both checksums must correspond for a satisfactory copying operation during the download process. If the checksums CRC_written and CRC_transmitted do not correspond, an error message “error in the CRC verification” is issued again 208.

If the flashware is not subject to any particular security class (step 210), no further checks are performed on the buffered flashware. If the flashware is subject to particular security classes, the hash value calculations which are necessary for the authentication of the flashware are carried (step 211) out immediately after the calculation of the CRC_written. Since at this time the flashware is still in the buffer (which has significantly shorter access times in comparison with the flash memory), the hash value calculations can be carried out by means of the data in the buffer, which leads to significantly more time efficient execution of the method.

The hash value calculations and the execution of the authentication methods must of course be carried out in accordance with the respective security class of the flashware. As already stated with respect to FIG. 1, public key encryption methods, in the form of what is referred to as an RSA method, are of particular interest here for flashware with a high security class or the abovementioned message authentication codes for flashware with a relatively low security level.

If the flashware is protected with a message authentication code, the unencrypted flashware is concatenated with the secret identification code and a hash value HMAC is calculated (step 212) by means of this combination. This calculated hash value HMAC is compared (stephs 213-216) with the hash value HMAC_transmitted which is transmitted during the download process. If the two values correspond, the authentication is successful 217 (verification ok), and if the two values do not correspond an error message is output (step 218) “error in HMAC-verification”.

If the software is subject to a relatively high security level (for example authentication by means of the RSA method discussed with respect to FIG. 1), the authentication method is carried out in accordance with this RSA method using the data buffered in the buffer.

In this case, the hash value (which is transmitted in encoded form) of the original software is deciphered (step 214) using the public key of the RSA method so that the hash value Hash_transmitted of the original software is obtained (step 215). A further hash value Hash (CCC) is then calculated for the flashware locatd in the buffer, and is compared with the decyphered hash value Hash_transmitted of the original software. If the two hash values correspond, the authentication is successful 217 (Verification ok). If the two hash values do not correspond, a fault message 218 “Error in Hash Verification” is output. If decyphering of the hash value which is transmitted in encoded form does not succeed, the authentication process ends prematurely and a fault message 219 “Error in Signature Verification” is output.

To summarize, the buffering of the downloaded flashware in a buffer with rapid access times permits the check methods which are necessary for the download process to be carried out more efficiently time-wise. Both the cyclic block protection methods and the authentication methods to be applied, depending on the security class, are carried out in the method according to the invention using the data buffered in the buffer. Repeated access to the flash memory for the execution of the block protection methods on the one hand, and for the execution of the authentication methods on the other, is successfully avoided. As a result, ultimately shorter flash times and thus saving in production time are achieved. In the case of a download into a control device of a motor vehicle, the download process for flashware must be carried out for the first time during the production of the motor vehicle, since such vehicles cannot be delivered with control devices without software.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-5. (canceled)

6. A method for checking data integrity of flashware in electronic control devices having at least one microprocessor, at least one flash memory, at least one boot sector, at least one buffer and at least one interface for downloading the flashware, said method comprising:
loading the flashware into a buffer; and
calculating at least two checksums for the flashware in the buffer;
wherein said calculating step includes performing a cyclic block protection method for checking for transmission errors, and a hash value calculation for checking the authenticity of the flashware.

7. The method as claimed in claim 6, wherein a cyclic block protection method, authentication by a message authentication code, and a hash value calculation are carried out for the flashware in the buffer.

8. The method as claimed in claim 6, wherein a cyclic block protection method, signature checking, and a hash value calculation are carried out for the software in the buffer.

9. The method as claimed in claim 8, wherein the signature checking is carried out using a public key method.

10. The method as claimed in claim 6, wherein, after the block protection method the security class of the software to be checked is interrogated.

11. The method as claimed in claim 7, wherein, after the block protection method the security class of the software to be checked is interrogated.

12. The method as claimed in claim 8, wherein, after the block protection method the security class of the software to be checked is interrogated.

13. The method as claimed in claim 9, wherein, after the block protection method the security class of the software to be checked is interrogated.
